(19) United States
(12) Patent Application Publication
(10) Pub. No.: US 2018/0356338 A1
(43) Pub. Date: Dec. 13, 2018

(54) GAS DETECTION SYSTEM

(71) Applicant: NEC CORPORATION, Tokyo (JP)

(72) Inventor: Akihiro TANAKA, Tokyo (JP)

(73) Assignee: NEC CORPORATION, Tokyo (JP)

(21) Appl. No.: 15/778,447

(22) PCT Filed: Nov. 18, 2016
(86) PCT No.: PCT/JP2016/084194

§ 371 Date: May 23, 2018

(30) Foreign Application Priority Data
Nov. 24, 2015 (JP) 2015-228374

(51) Int. Cl. G01N 21/3504

(52) U.S. Cl. CPC G01N 21/3504; G01N 2201/063; G01N 2201/061; G01N 2201/0833

(57) ABSTRACT

In order to perform gas detection at multiple locations with a simple configuration and at a low cost, the gas detection device is provided with: a transmission unit for outputting to a transmission path, as a first optical signal, pulse light that has a temporally changing wavelength and that is generated by pulse light modulated by an optical wavelength modulator; and a reception unit for receiving a second optical signal output from a sensor head outputting the first optical signal propagated through the atmosphere as the second optical signal, converting the second optical signal received into an electric the signal detecting, by each sensor head, a predetermined type of gas contained in the atmosphere based on a temporal change in amplitude of the electric signal, and outputting a result of detection of the gas.

### TECHNICAL FIELD

The present invention relates to a gas detection system, and especially relates to a gas detection system for optically detecting a gas at many points.

### BACKGROUND ART

In recent years, an attention is attracted to a natural gas having a less amount of a carbon dioxide emissions that becomes a factor of a global warming compared with a coal and a coal oil, and a natural gas consumption in each country increases. Along with this, an importance of a gas detection system for detecting the leaking of the gas in the distribution network of the natural gas increases.

A main component of a natural gas is methane molecule (CH₄). There is a case where a semiconductor sensor is used for a detection of methane molecule (hereinafter simply referred to as “methane”). The semiconductor sensor detects, as a gas concentration, a change in a resistance caused when a metal oxide semiconductor contacts the gas to be detected. However, when using the semiconductor sensor, since it is necessary to heat an electrode of the sensor, the sensor needs to have an explosion-proof structure. Since a lifespan of the semiconductor sensor is generally about a few months, maintenance works such as calibration and exchange of a sensor are necessary. As a result, the gas detection system using the semiconductor sensor has problems that an operational cost is high in addition to a high construction cost of the system.

As an alternative to a method using the semiconductor sensor, a gas detection device using the light absorption of the gas is known. A gas detection device disclosed in PTL 1 can branch a pulse light sent from a light source (pulse light generation device) and can detect the gas at a plurality of points. NPL 1 discloses a wavelength conversion technique for shifting the carrier frequency of the optical signal input to the optical single side band (SSB) modulator by a constant frequency. Further, PTL 2 discloses a multipoint gas concentration measuring device for measuring the gas concentrations at multiple places with small number of optical fibers.

### CITATION LIST

### Patent Literature

[PTL 1] JP. 9-043141 A
[PTL 2] JP. 6-148071 A

### Non Patent Literature

[NPL 1] Shimozu, et al., “Wideband wavelength conversion with an optical single sideband modulator,” Electronics Society Conference of the Institute of Electronics, Information and Communication Engineers, C-3-73, Japan (year 2000)

### SUMMARY OF INVENTION

### Technical Problem

The gas detection device disclosed in PTL 1, using the optical signal having a wide spectral width, to measure the absorption of the gas, requires a light source that generates the pulse light whose output is high and whose spectrum is broad. However, if the pulse light having the wide spectrum propagates through the optical fiber, due to the chromatic dispersion, the pulse width is widened and when the return light pulses from the plurality of measurement points are returned to the gas detection device, due to the temporal overlapping, the measurement of the gas concentration is not possible. The gas detection device disclosed in PTL 1, to separate a wavelength component that receives the absorption of the gas molecule from the wavelength component that does not receive the absorption of the gas molecule, provides, to a receiving side, a wavelength selective separator and a pulse light delayer. As a result, the optical circuit of the receiving side also becomes complicated. In this manner, the gas detection device disclosed in PTL 1 has problems that its configuration is complicated and the cost is high.

The multipoint gas concentration measuring device disclosed in PTL 2 has a configuration in which a single optical fiber is branched by pieces of branching and coupling means. In the device disclosed in PTL 2, when the reflected lights from the plurality of measurement points are received, a pulsed light signal is used in such a way that the reflected lights are not overlapped. However, the device disclosed in PTL 2 has a problem that a distance between the measurement points may not be reduced. The reason is as follows. The device disclosed in PTL 2, to conduct the wavelength modulation, changes the drive current of the light source (laser) or the temperature. To cover the absorption spectrum of the methane, the wavelength needs to be changed by about 5 GHz. To obtain the wavelength change by changing the drive current of the laser, a time of several μs (microsecond) is required. As a result, the pulse light sent to the gas cell has the width of several μs or more. However, since the width corresponds to the propagation distance of several km on the optical fiber, when the device disclosed in PTL 2 receives the reflected lights, to avoid the overlapping of the reflected lights, it is necessary to separate the distance between each of the measurement points by several km or more. In other words, in the device disclosed in PTL 2, it is not possible to realize a multipoint gas concentration monitoring system having a high distance resolution.

In the device disclosed in PTL 2, between pieces of light branching and joining means, an optical fiber is spooled and provide in such a way that a distance between the measurement points can be increased. However, in this case, due to the propagation loss by the spooled optical fiber, a distance by which the gas concentration can be monitored is largely restricted. For example, the propagation loss of the Single Mode Fiber (SMF) at 1.65 μm where the absorption spectrum of the methane molecule is present is about 0.4 dB/km. Accordingly, if, between each of the measurement points, the optical fiber for the spooling of 1 km is provided, in the system with 25 measurement points, the excessive loss of up to 20 dB is caused in round trip. As a result, the detection accuracy of the gas is significantly deteriorated, and the extension of the propagation distance and the increase in the measurement points are largely restricted.

(Object of Present Invention)

An object of the present invention is to provide a technique for detecting the gas of the multiple locations with the high distance resolution, the simple configuration, and at a low cost.

### Solution to Problem

The gas detection system according to the present invention includes transmission means for outputting the pulse light whose wavelength is temporally modulated by an optical wavelength modulator to the transmission path as the first optical signal; a plurality of sensor heads for propagating the first optical signal through an atmosphere and outputting the first optical signal that has propagated the atmosphere as the second optical signal, reception mean for receiving the second optical signal to convert the second optical signal into an electric signal, based on the temporal variation of the amplitude of the electric the signal detecting the predetermined types of gas included in the atmosphere for each of the sensor head, and outputting the detection result of the gas, and branching means for branching the transmission path, via the branched transmission path, connecting the transmission means with the sensor head, and via the branched transmission path, connecting the sensor head with the reception means.

The gas detection device according to the present invention includes the transmission means for outputting the pulse light whose wavelength is temporally changed to the transmission path as the first optical signal; and reception means for receiving the second optical signal that is output from the sensor head that outputs the first optical signal that has propagated the atmosphere as the second optical signal, converting the second optical signal into the electric signal, based on the temporal variation of the amplitude of the electric signal, detecting the predetermined types of gas included in the atmosphere for each sensor head, and outputting the detection result of the gas.

The gas detection method according to the present invention includes outputting the pulse light whose wavelength is temporally changed, as the first optical signal, to the transmission path; and receiving the second optical signal output from the sensor head that outputs the first optical signal that has propagated the atmosphere as the second optical signal, converting the second optical signal into the electric signal, based on the temporal variation of the amplitude of the electric the signal, detecting the predetermined types of gas included in the atmosphere for each sensor head, and outputting the detection result of the gas.

### Advantageous Effects of Invention

The gas detection system, the gas detection device, and the gas detection method according to the present invention allow conducting the gas detection of the multiple locations with the high distance resolution, the simple configuration, and at a low cost.

### BRIEF DESCRIPTION OF DRAWINGS

FIG. 1 is a block diagram illustrating a configuration example of a gas detection system according to a first example embodiment.

FIG. 2 is a block diagram illustrating a configuration example of an optical wavelength modulator.

FIG. 3 is a drawing for explaining a generation example of an optical signal in a control device.

FIG. 4 is a drawing conceptually illustrating a waveform example of an optical signal received by a photodiode in the first example embodiment when there is no gas leaking.

FIG. 5 is a drawing conceptually illustrating a waveform example of an optical signal received by a photodiode in the first example embodiment when there is gas leaking.

FIG. 6 is a block diagram illustrating a configuration example of a gas detection system according to a second example embodiment.

FIG. 7 is a drawing conceptually illustrating the waveform example of the optical signal received by the photodiode in the second example embodiment when there is no gas leaking.

FIG. 8 is a drawing conceptually illustrating the waveform example of the optical signal received by the photodiode in the second example embodiment when there is gas leaking.

FIG. 9 is a block diagram illustrating a configuration example of a gas detection system according to a third example embodiment.

FIG. 10 is a drawing conceptually illustrating the waveform example of the optical signal received by the photodiode in the third example embodiment when there is no gas leaking.

FIG. 11 is a drawing conceptually illustrating the waveform example of the optical signal received by the photodiode in the third example embodiment when there is gas leaking.

FIG. 12 is a block diagram illustrating a configuration example of the gas detection system according to the second variation of the third example embodiment.

FIG. 13 is a drawing schematically illustrating a peak shape of the optical signal received in the gas detection system according to the second variation of the third example embodiment.

FIG. 14 is a block diagram illustrating a configuration example of the gas detection system according to the third variation of the third example embodiment.

FIG. 15 is a drawing schematically illustrating the peak shape of the optical signal received in the gas detection system according to the third variation of the third example embodiment.

FIG. 16 is a drawing for explaining an example of a correspondence between a reflection wavelength set to an FBG and a peak waveform of an optical signal received by a control device.

FIG. 17 is a block diagram illustrating a configuration example of a gas detection device according to a fourth example embodiment.

FIG. 18 is a flowchart illustrating examples of operation procedures of a gas detection device according to a fourth example embodiment.

### DESCRIPTION OF EMBODIMENTS

### First Example Embodiment

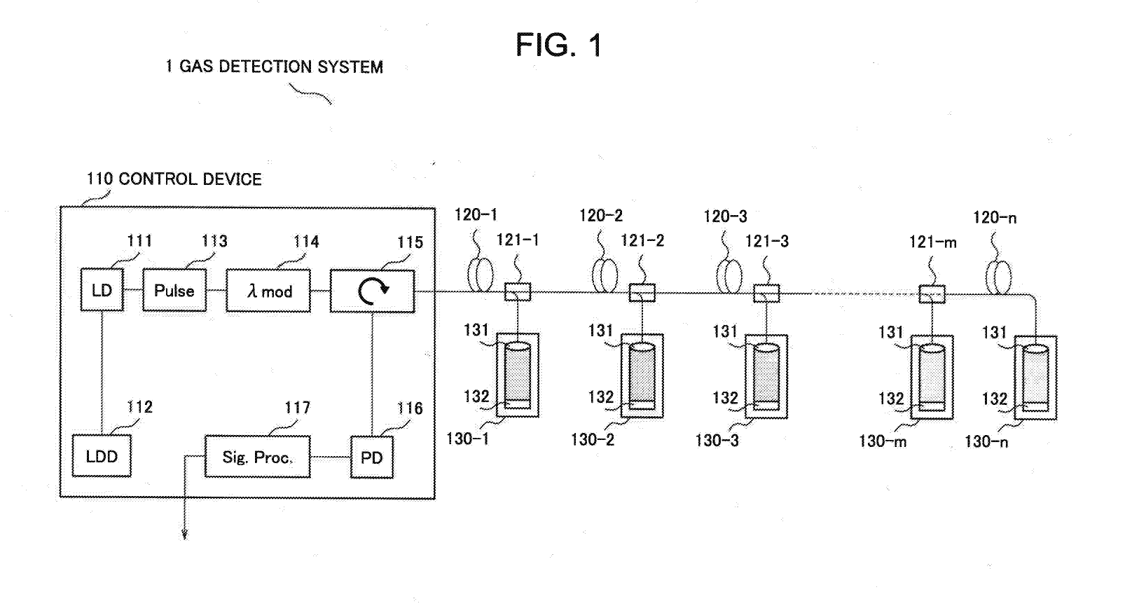

With reference to FIG. 1 to FIG. 5, a first example embodiment of the present invention is described. FIG. 1 is a block diagram illustrating a configuration example of a gas detection system 1 according to the first example embodiment of the present invention. The gas detection system 1 includes a control device 110, optical fibers 120-1 to 120-n, optical couplers 121-1 to 121-m, and sensor heads 130-1 to 130-n. The n is an integer of 2 or more and m=n−1.

Hereinafter, the optical fibers 120-1 to 120-n is collectively referred to as an optical fiber 120. Similarly, the optical couplers 121-1 to 121-m and the sensor heads 130-1 to 130-n are also collectively referred to as an optical coupler 121 and a sensor head 130.

The control device 110 is connected to the sensor head 130 via a transmission path, that is, the optical fiber 120. The control device 110 includes a laser diode (LD) 111, a laser diode driver (LDD) 112, an optical intensity modulator (Pulse) 113, an optical wavelength modulator (λ mod) 114, an optical circulator 115, a photodiode (PD) 116, and a signal processing unit (Sig. Proc.) 117.

On the optical fiber 120, the optical couplers 121-1 to 121-m are arranged in series. One branch of the p-th (1≤p≤m−1) optical coupler 121-p is connected to the sensor head 130 p. The other branch of the optical coupler 121-p is connected to the optical fiber 120-q (q=p+1). For example, one branch of the optical coupler 121-1 is connected to the sensor head 130-1. The other branch of the optical coupler 121-1 is connected to the optical fiber 120-2. However, the optical coupler 121-m that is most distant from the control device 110 is connected to the sensor head 130-m and the optical fiber 120-n. The optical fiber 120-n is connected to the sensor head 130-n.

The sensor head 130 is a sensor used for measuring a concentration of the methane included in surrounding atmosphere. The sensor head 130 includes a lens 131 and a mirror 132. Since the lens 131 and the mirror 132 are common to the sensor heads 130-1 to 130-n, in FIG. 1, the lens 131 and the mirror 132 are simply described as a lens 131 and a mirror 132. The space between the lens 131 and the mirror 132 is exposed to the surrounding atmosphere of the sensor head 130.

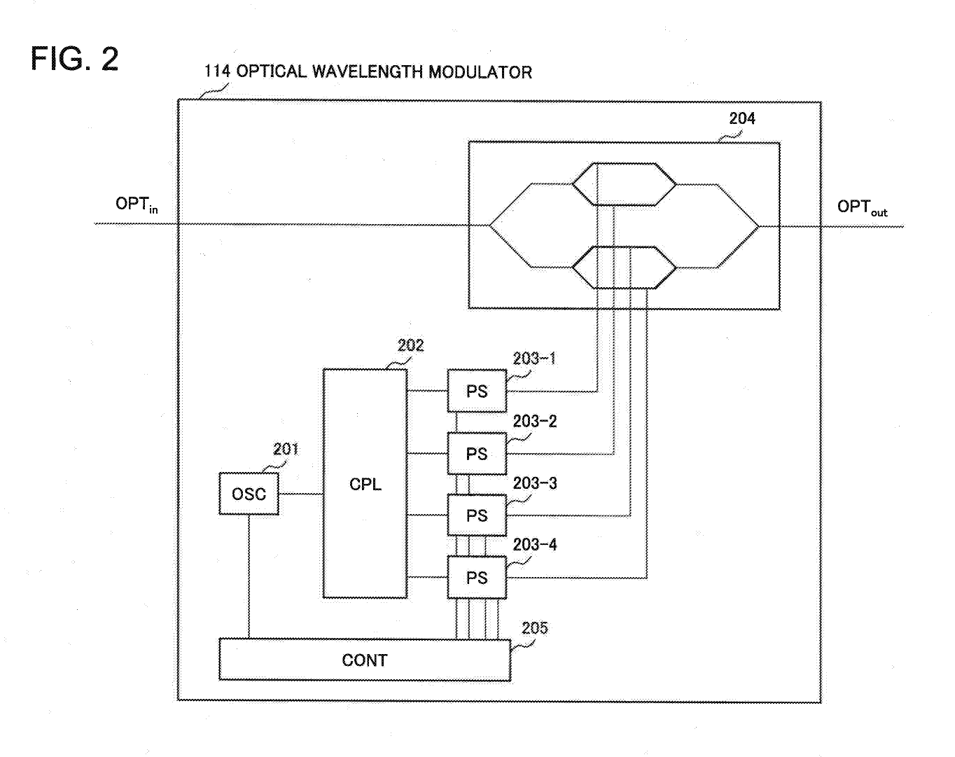

FIG. 2 is a block diagram illustrating a configuration example of an optical wavelength modulator 114. A variable oscillator (OSC) 201 is an oscillator of the electric signal whose output frequency is variable. The electric signal output from the variable oscillator 201 is split into four branches by a coupler (CPL) 202. A phase of each of the split signals is adjusted by phase shifters (PS) 203-1 to 203-4. The four signals output from the phase shifters 203-1 to 203-4 are respectively input to the four ports of the optical single side band (SSB) modulator 204. A control unit (CONT) 205 controls the variable oscillator 201 and the phase shifter 203. To the OPTin of the optical SSB modulator 204, the pulse light is input from an optical intensity modulator 113. The optical SSB modulator 204 wavelength-modulates the pulse light and outputs the wavelength-modulated pulse light from the OPTout. The OPTout is connected to the optical circulator 115.

(Operation of Gas Detection System 1)

The drive current and the temperature of a laser diode 111 are controlled by a laser diode driver 112. The laser diode 111 outputs the continuous light having the wavelength of 1.65 μm. The wavelength is known as the wavelength having the large absorption by the methane. The output continuous light having the wavelength of 1.65 μm is pulse-modulated by the optical intensity modulator 113 and becomes the pulse light with the predetermined interval. The pulse light is wavelength-modulated by the optical wavelength modulator 114. The wavelength-modulated pulse light is, via the optical circulator 115, sent to the optical fiber 120-1. The optical signal that propagates the optical fiber 120, each time the optical signal passes the optical coupler 121, is split into two branched optical signals. One of the two branched optical signals is input to the sensor head 130, and the other is continuously transmitted by the optical fiber 120.

The n sensor heads 130 are dispersed and installed to a place where the detection of the leaking of the gas is needed. The sensor head 130 emits the optical signal that is input from the optical coupler 121, from an optical fiber end and converts the emitted optical signal, using the lens 131, into a collimated optical signal. The collimated optical signal propagates the atmosphere of the place where the sensor head 130 is installed and is reflected by the mirror 132 toward a direction of the lens 131. The lens 131 converges the reflected collimated optical signal to the optical fiber that emits the optical signal. The optical signal that is converged to the optical fiber propagates the optical coupler 121 and the optical fiber 120 in a reverse direction and is received by the control device 110. In this way, the optical signal transmitted from the control device 110 is turned back by the sensor head 130 and is received by the control device 110.

The optical circulator 115 sends the optical signal output from the optical wavelength modulator 114 to the optical fiber 120-1 and guides the optical signal turned back by the sensor head 130 to a photodiode 116. The photodiode 116 converts the received optical signal into the electric signal. The signal processing unit 117, by processing the electric signal output from the photodiode 116, detects the methane included in the atmosphere of each point where the sensor head 130 is installed.

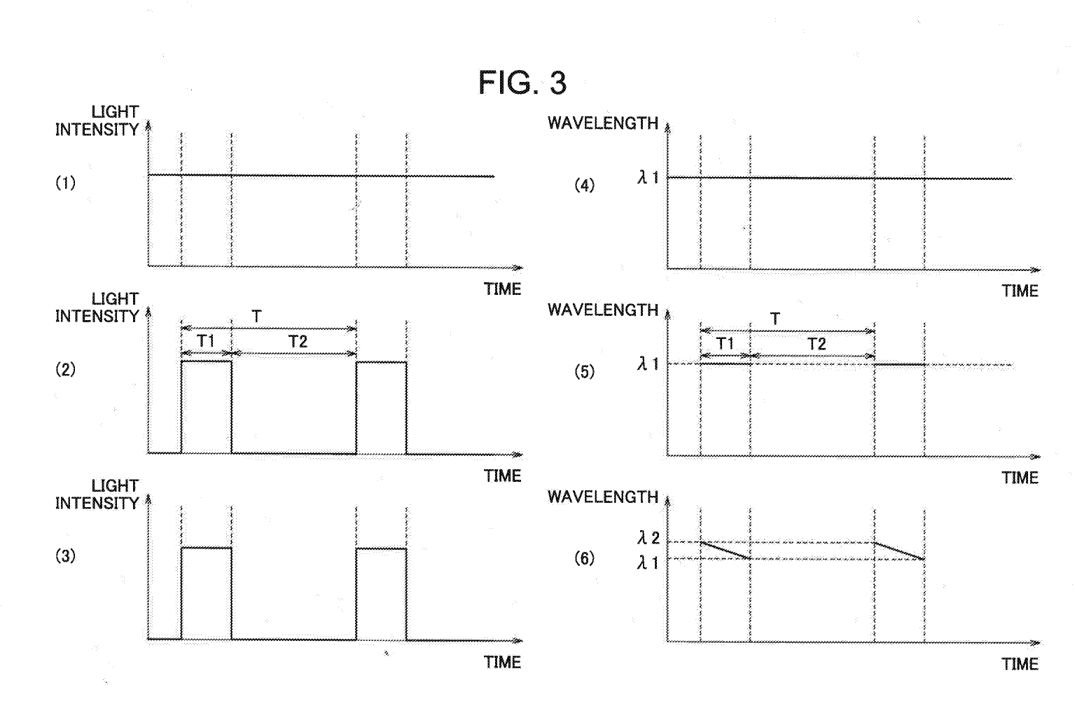

FIG. 3 is a drawing for explaining a generation example of an optical signal in the control device 110. In (1) to (3) of FIG. 3, a vertical axis represents the light intensity, a horizontal axis represents a time, and the time change of the intensity of the optical signal is represented. In (4) to (6) of FIG. 3, a vertical axis represents the wavelength of the optical signal, a horizontal axis represents a time, and the time change of the wavelength of the optical signal is represented. All of light intensity, the wavelength, and the time are arbitrary scales. The (5) and (6) of FIG. 3 do not illustrate the wavelength of the time when there is no optical signal.

Both the light intensity and the wavelength λ1 of the optical signal, immediately after the optical signal is output from the laser diode 111, are constant ((1) and (4) of FIG. 3). The optical intensity modulator 113 modulates the optical signal output from the laser diode 111 and generates the pulse light having the length T1 and the interval T2. The period T of the pulse light is T1+T2. Although the optical intensity modulator 113 modulates the light intensity of the optical signal in a pulse-like manner, the wavelength λ1 of the optical signal remains constant ((2) and (5) of FIG. 3).

The optical wavelength modulator 114 modulates the wavelength of the pulse light output from the optical intensity modulator 113. In the present example embodiment, the optical wavelength modulator 114 changes the wavelength of the pulse light from λ2 to λ1 during a light-emitting period T1 ((6) of FIG. 3). With respect to the wavelength of the pulse light, all pulses are modulated similarly. In (6) of FIG. 3, an example is illustrated in which the wavelength of the pulse light gradually decreases along with the elapse of the light-emitting time. However, the wavelength change of the pulse light is not limited to the example of (6) of FIG. 3. For example, the pulse light may be modulated in such a way that with the elapse of the light-emitting time, the wavelength gradually increases. The wavelength of the pulse light is modulated in such a way as to be unique with respect to the elapsed time from the emission of the pulse light to the quenching.

The wavelength modulation of the pulse light by the optical wavelength modulator 114 may be conducted with reference to the wavelength conversion technique disclosed in NPL 1. In the wavelength conversion technique disclosed in NPL 1, by the sine wave of the constant frequency output from the oscillator, the input carrier frequency of the optical signal is shifted by the constant frequency in the optical SSB modulator 204.

However, if the method disclosed in NPL 1 is only simply applied, since only the mere wavelength conversion is conducted, in the optical wavelength modulator 114 according to the present example embodiment, to conduct the wavelength sweeping, the variable oscillator 201 is used. A control unit 205 changes the output frequency of the variable oscillator 201 based on the period T and the light-emitting period T1 of the pulse light. As a result, as illustrated in (6) of FIG. 3, the modulation waveform obtained by, within the light-emitting period T1 of the pulse light, sweeping the wavelength from λ2 to λ1 is provided. The control unit 205 may further control the phase shifter 203 in such a way that the pulse light having the desired feature can be obtained.

Instead of the variable oscillator 201, Arbitrary Waveform Generator (AWG) may be used. For example, the AWG of 10 G (giga) sample/second is used and for each 10 sampling point, the frequency is increased by 0.1 GHz in such a way that within the time of 50 ns (nano second), the frequency sweep of 5.0 GHz can be conducted. Since the absorption spectrum width of the methane is about 3.0 GHz, the frequency sweep that can sufficiently cover the absorption spectrum is realized in a short time. Further, since the pulse width of 50 ns corresponds to the fiber length of about 10 m, even if the sensor head is arranged at relatively short intervals of 10m, the return light from each sensor head is temporally distinguished. In other words, if a distance between the installation points of the sensor head is about 10 m, it is possible to detect the gas at each point without receiving the influence of the signal from other sensor heads.

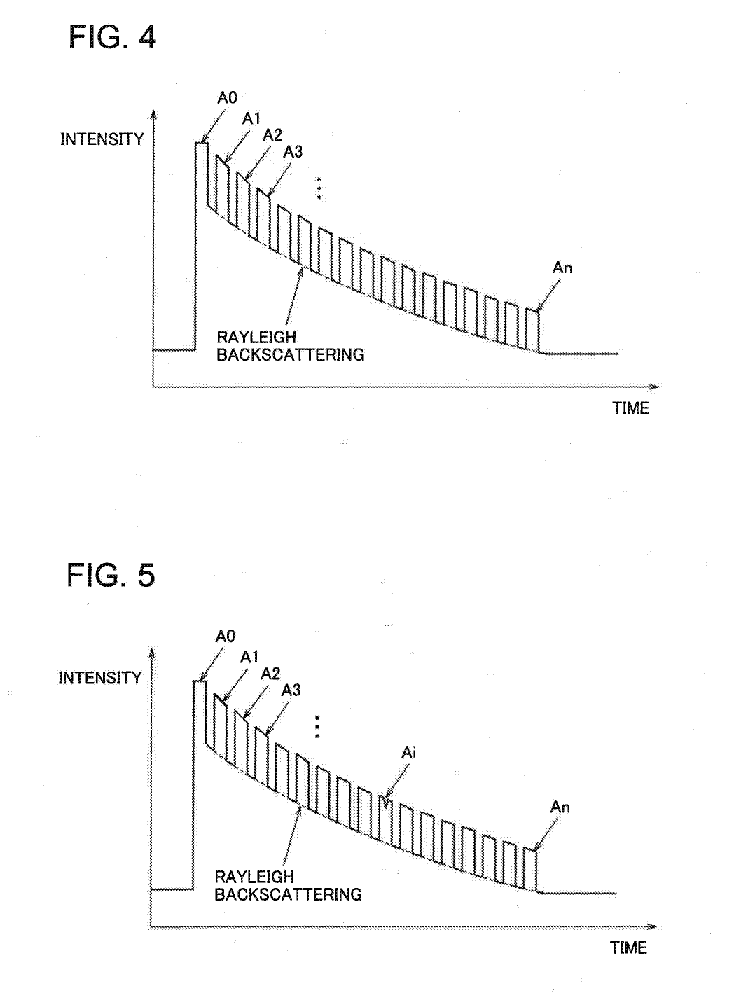

FIG. 4 and FIG. 5 are drawings conceptually illustrating the waveform examples of the optical signals received by the photodiodes 116. FIG. 4 illustrates an example in which there is no gas leaking in any points where the sensor head 130 is arranged.

FIG. 4 and FIG. 5 illustrate that with respect to a single pulse included in the optical signal, from the sensor head 130, the optical signal including the plurality of peaks is received. A position on the time axis of each peak is determined by the round-trip time of the optical signal, i.e., a distance between the control device 110 and the sensor head 130 of the optical signal. In the present example embodiment, the respective sensor heads 130 are provided at regular intervals and in such a way that all distances from the control device 110 are different. Thus, peaks of FIG. 4 and FIG. 5 are also provided at regular intervals.

The first peak (A0) illustrated in FIG. 4 is caused because the optical signal transmitted from the optical wavelength modulator 114 is directly received by the photodiode 116 due to the incompleteness of the directivity of the optical circulator 115. The second and subsequent peaks (A1 to An) are peaks respectively corresponding to the pulse light turned back from the sensor heads 130-1 to 130-n. The sensor heads 130 are connected one by one in advance and a timing at which the corresponding peaks A1 to An occur is measured in advance in such a way as to know the correspondence between the received peaks A1 to An and the sensor heads 130-1 to 130-n. The width of the peak is equal to the light-emitting period T1 of the pulse light and the interval of the peak is determined by the difference in the response time from the sensor head 130 of the optical signal in the control device 110. Further, the period T of the pulse light is set to be longer than a time from the peak A0 to the peak An.

In FIG. 4 and FIG. 5, the dotted line as “Rayleigh backscattering” and the curve indicating the period during which there is no pulse light represent the intensity of the received light caused by the Rayleigh backscattering of the optical fiber. The intensity of the Rayleigh backscattering, as the distance from the control device 110 to the sensor head increases, decreases due to the transmission loss of the optical fiber 120 and the branch loss of the optical coupler 121. When in all points where the sensor head 130 is installed, there is no gas leaking, as illustrated in FIG. 4, all of the peaks of the pulse light turned back from the sensor head 130 indicate the gentle intensity change. Note that the temporal variation of the signal intensity by the Rayleigh backscattering illustrated in FIG. 4 and FIG. 5 is one example representing a concept and the intensity of the Rayleigh backscattering differs depending on the number of the optical coupler 121 and the optical feature of the optical fiber 120.

On the other hand, FIG. 5 illustrates an example in which, in points where i-th (1≤i≤n) sensor heads are installed, as result of the gas leaking, the methane gas concentration in the atmosphere is high. In this case, unlike FIG. 4, at the peak of the pulsed light (Ai) returned from the i-th sensor head, the dip caused by the absorption of the optical signal by the methane gas is observed. By detecting the amount of the dip in the photodiode 116 and the signal processing unit 117, it is possible to know the concentration of the methane gas around the i-th sensor head. The photodiode 116 outputs the electric signal having the amplitude that is proportional to the light intensity to the signal processing unit 117. The signal processing unit 117 monitors the temporal intensity change of the electric signal at the peak of the pulse light for each peak and detects the dip by the absorption of the gas.

The below is an example of the operation procedure of the signal processing unit 117. The signal processing unit 117 detects the depth of the dip of the i-th peak (i.e., amplitude change). When the amplitude change is larger than the predetermined threshold value, the signal processing unit 117 determines that the gas is leaking around the sensor head 130-i and outputs the alarm to the outside of the control device 110. Alternatively, the signal processing unit 117, based on the depth of the dip of the i-th peak, calculates the concentration of the gas around the sensor head 130-i and outputs the calculated gas concentration to the outside of the control device 110. Generally, as the concentration of the gas is high, the light absorption by the gas increases and the dip becomes deep. Accordingly, by measuring in advance the relationship between the concentration of the gas and the depth of the dip, based on the depth of the dip, the concentration of the gas can be calculated.

(Effect of First Example Embodiment)

The gas detection system 1 according to the first example embodiment can conduct the gas detection of the multiple locations easily and inexpensively. The first reason thereof is because since the wavelength of the output light of the light source of the single wavelength is changed using the optical wavelength modulator 114, the light source that generates the pulse light whose output is high and whose spectrum is broad is not needed. The second reason is because since the process of the turned back optical signal is conducted only by the photodiode 116 and the signal processing unit 117, to the receiving side, the complicated optical circuit is not needed.

The gas detection system 1 according to the first example embodiment can realize the gas detection system having the high distance resolution. The reason thereof is because the wavelength of the short pulse output from the light source of the single wavelength is changed using the optical wavelength modulator 114. With this configuration, compared to when the pulse light having the wide spectrum is used, the widening of the pulse width of the optical signal can be reduced and compared to when the wavelength modulation is conducted based on the drive current and the temperature of the laser, with the short pulse, the desired wavelength change can be obtained. As a result, even when the distance between the sensor heads 130 is small, it is possible to avoid that the pulse lights returned from the plurality of measurement points temporally overlap at the control device 110, and the high distance resolution can be obtained. The gas detection system 1 according to the first example embodiment, to provide the above described effects, does not need to provide, on the optical fiber 120, the optical fiber spool.

The gas detection system 1 according to the first example embodiment can reduce the operational cost of the gas detection system. The reason thereof is because compared to when for each sensor head, the optical fiber is laid from the control device 110, the gas detection system 1, by inserting the optical coupler to the single fiber, can conduct the gas detection of the many points. A configuration in which the optical coupler is inserted to the single fiber facilitates the construction and the maintenance of the system and facilitates the introduction of the gas detection system to the region where there are few free optical fibers in the existing optical fiber network.

(Variation of First Example Embodiment)

Below, a variation that provides effects similar to the effects of the gas detection system 1 according to the first example embodiment is described.

In the first example embodiment, as the optical wavelength modulator, the optical SSB modulator is used. However, instead of the optical SSB modulator, In-phase/Quadrature (IQ) modulator used for the large-capacity optical communication technology may be used in such a way that the wavelength modulation is performed. Further, the wavelength modulation can be performed by using the modulator driver of the large amplitude and changing the applied voltage of the optical phase modulator temporally.

An optical amplifier may be inserted to one of or both of spaces between the laser diode 111 and the optical circulator 115, and the space between the optical circulator 115 and the photodiode 116. By using the optical amplifier, it is possible to improve a signal-to-noise ratio of the optical signal received from the sensor head 130.

When the sensor head 130 according to the first example embodiment spatially propagates the optical signal, the sensor head 130 once reflects the optical signal using the mirror 132. However, using the plurality of mirrors, by reflecting the optical signal a number of times, the propagation path of the optical signal in the space may be increased. By using the sensor head having such configuration, the absorption of the optical signal by the gas increases and it is possible to detect the gas having the less concentration.

FIG. 3 illustrates an example in which the wavelength of the optical signal linearly changes in the pulse. However, the change in the wavelength may be overlapped to the sine wave and the gas concentration may be calculated based on a wavelength modulation spectroscopy (WMS) method. By using the WMS method, it becomes possible to measure the gas concentration with more high sensitivity. The linearly wavelength modulation and the sinusoidal wavelength modulation may be conducted by individual optical wavelength modulators.

NPL 1 discloses that, by the wavelength conversion, the higher-order sidebands are generated. To suppress such higher-order sidebands, at the latter part of the optical wavelength modulator 114, an optical bandpass filter may be arranged. By adding the optical bandpass filter that removes the higher-order sidebands, since the noise is suppressed, the measurement with higher accuracy becomes possible.

In the present example embodiment, an example in which, by using the optical signal having the wavelength of 1.65 μm, the methane is detected is represented. As the wavelength of the optical signal, the wavelength corresponding to another absorption spectrum of the methane may be used. Alternatively, the absorption spectrum of the gas molecules different from the methane may be monitored at the wavelength other than 1.65 μm and the gas other than the methane may be detected. Further, by using the optical signals having the plurality of wavelengths, the plurality of different types of gas may be detected.

### Second Example Embodiment

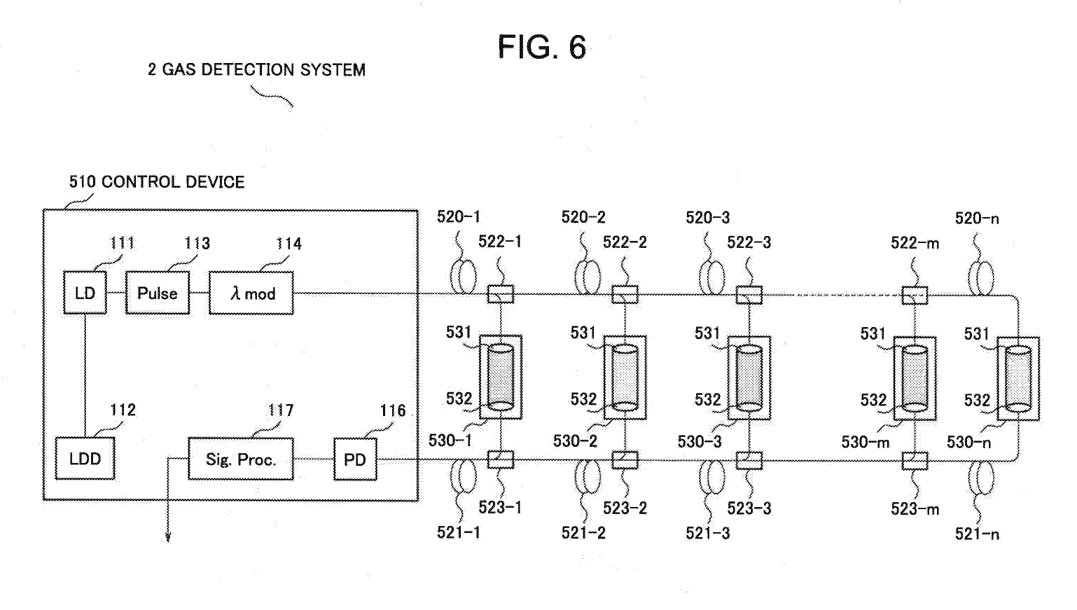

With reference to FIG. 6 to FIG. 8, the second example embodiment of the present invention is described. In the first example embodiment, the control device 110 and each sensor head 130 are connected via a single optical fiber. In the second example embodiment, two optical fibers separated for the transmission and the reception of the optical signal are used.

FIG. 6 is a block diagram illustrating a configuration example of a gas detection system 2 according to the second example embodiment of the present invention. The gas detection system 2 includes a control device 510, optical fibers 520-1 to 520-n and 521-1 to 521-n, optical couplers 522-1 to 522-m and 523-1 to 523-m, and sensor heads 530-1 to 530-n. The n is the integer of two or more and m=n−1. Hereinafter, optical fibers 520-1 to 520-n are collectively referred to as an optical fiber 520. Similarly, optical fibers 521-1 to 521-n, optical couplers 522-1 to 522-m, optical couplers 523-1 to 523-m and sensor heads 530-1 to 530-n are collectively referred to as an optical fiber 521, an optical coupler 522, an optical coupler 523, and a sensor head 530.

The control device 510 and the sensor head 530 are connected, via a transmission path, i.e., the optical fibers 520 and 521. The control device 510 includes a laser diode (LD) 111, a laser diode driver (LDD) 112, an optical intensity modulator (Pulse) 113, an optical wavelength modulator (λ MOD) 114, a photodiode (PD) 116, and a signal processing unit (Sig. Proc.) 117. As seen from the above, the control device 510 differs from the control device 110 according to the first example embodiment in that the control device 510 does not include the optical circulator 115. In other words, in the control device 510, the optical wavelength modulator 114 sends the wavelength-modulated optical signal to the optical fiber 520-1 and the photodiode 116 receives the optical signal that passes the sensor head 530 from the optical fiber 521-1. Components of the control device 510 are common to the components of the control device 110 according to the first example embodiment except the above. Accordingly, the laser diode 111, the laser diode driver 112, the optical intensity modulator 113, the optical wavelength modulator 114, the photodiode 116 and the signal processing unit 117 that are common to those in the first example embodiment are denoted with the name and the reference numeral that are similar to those in the first example embodiment and descriptions thereof are omitted.

In the optical fibers 520 and 521, the optical couplers 522 and 523 are arranged respectively. One of the branches of the optical couplers 522, 523 is connected to the sensor head 530. Each sensor head 530 includes the lenses 531 and 532.

On the optical fiber 520, optical couplers 522-1 to 522-m are arranged in series. One of the branches of a p-th (1≤p≤m−1) optical coupler 522-p is connected to the lens 531 of the sensor head 530-p. The other of the branches of the optical coupler 522-p is connected to the optical fiber 520-q (q=p+1). For example, one of the branches of the optical coupler 522-1 is connected to the lens 531 of the sensor head 530-1. The other of the branches of the optical coupler 522-1 is connected to the optical fiber 520-2. However, the optical coupler 522-m that is most distant from the control device 510 is connected to the sensor head 530-m and the optical fiber 520-n. The optical fiber 520-n is connected to the lens 531 of the sensor head 530-n.

On the optical fiber 521, the optical couplers 523-1 to 523-m are arranged in series. One of the branches of a p-th (1≤p≤m−1) optical coupler 523-p is connected to a lens 532 of the sensor head 530-p. The other of the branches of the optical coupler 523-p is connected to the optical fiber 521-q (q=p+1). For example, one of the branches of the optical coupler 523-1 is connected to the lens 532 of the sensor head 530-1. The other of the branches of the optical coupler 523-1 is connected to the optical fiber 521-2. However, the optical coupler 523-m that is most distant from the control device 510 is connected to the sensor head 530-m and the optical fiber 521-n. The optical fiber 521-n is connected to the lens 532 of the sensor head 530-n.

(Operation of Second Example Embodiment)

The continuous light having the wavelength of 1.65 μm that is output from the laser diode 111 is pulse-modulated by the optical intensity modulator 113 and wavelength-modulated by the optical wavelength modulator 114. The wavelength-modulated optical signal is transmitted to the optical fiber 520-1. The optical signal that propagates the optical fiber 520-1 is split into two branched optical signals by the optical coupler 522-1. One of two branched optical signals is input to the sensor head 530-1 and the other is sent to the optical coupler 522-2 via the optical fiber 520-2. Below, in the optical couplers 522-2 to 522-m, the optical signal is split into two branches and finally the optical signal is distributed into the n sensor heads 530-1 to 530-n.

The sensor head 530 converts the optical signal input from the optical couplers 522-1 to 522-m or the optical fiber 520-n into the collimated optical signal using the lens 531. The collimated optical signal propagates the atmosphere of the place where the sensor head 530 is installed. The collimated optical signal is converged to the optical fiber end of a side of the optical fiber 521 by the lens 532. The converged optical signal propagates the optical coupler 523 and the optical fiber 521 and is received by the control device 510. In this manner, the optical signal transmitted from the control device 510 is received by the control device 510 via the optical fiber 520, the optical coupler 522, the sensor head 530, the optical coupler 523 and the optical fiber 521.

The photodiode 116 included in the control device 510 converts the received optical signal into the electric signal. The signal processing unit 117, by processing the electric signal output from the photodiode 116, detects the methane contained in the atmosphere of each point where the sensor head 530 is installed.

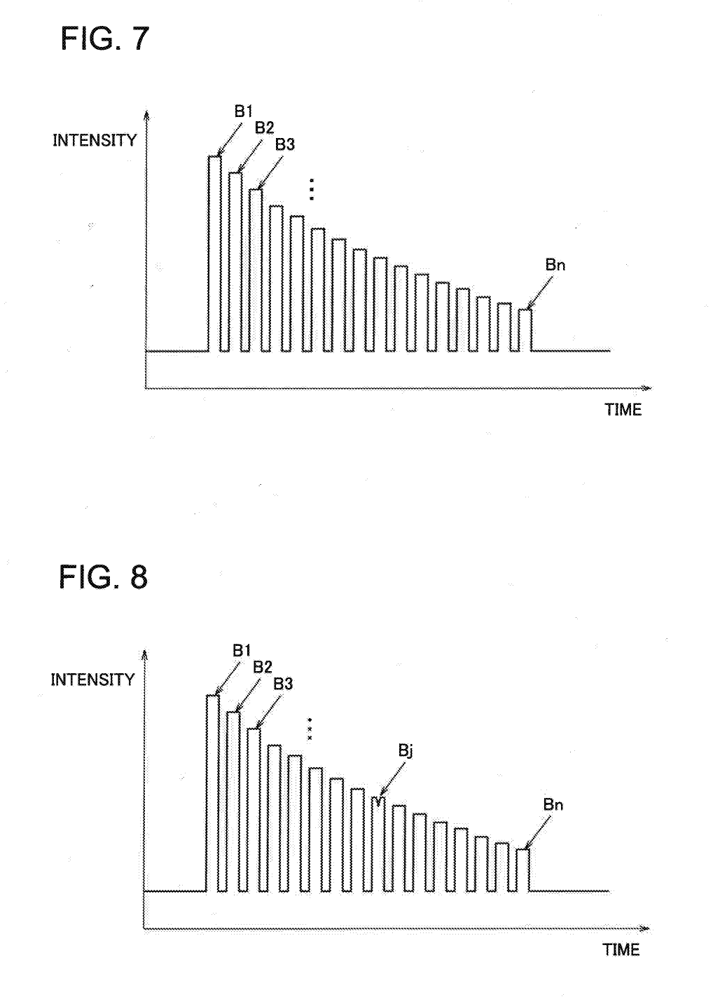

FIG. 7 and FIG. 8 are drawings conceptually illustrating the waveform examples of the optical signals received by the photodiode 116 in the second example embodiment. Comparing FIG. 7 and FIG. 8 with FIG. 4 and FIG. 5 of the first example embodiment, in FIG. 7 and FIG. 8, there is no peak corresponding to the first peak (A0) due to the incompleteness of the directivity of the optical circulator. In the second example embodiment, since different optical fibers 520, 521 are used for forward and backward paths of the optical signal, in FIG. 7 and FIG. 8, no fluctuation of the base line due to the Rayleigh backscattering is caused.

FIG. 7 is a drawing illustrating when, in all points where sensor head is arranged, there is no gas leaking. The plurality of peaks (B1 to Bn) are respectively peaks corresponding to the pulse light turned back from the sensor heads 530-1 to 530-n. The sensor heads 530 are connected in advance one by one and a timing at which the corresponding peaks B1 to Bn occur is measured in advance in such a way as to know the correspondence between the received peaks B1 to Bn and the sensor heads 530-1 to 530-n. When, in the points where the sensor heads 530-1 to 530-n are installed, there is no gas leaking, all peaks of the pulsed light returned from the sensor heads 530-1 to 530-n represent the gentle change.

On the other hand, FIG. 8 illustrates an example in which, in the points where the j-th (1≤j≤n) sensor head is installed, as result of gas leaking, the methane gas concentration in the atmosphere is high. In this case, unlike FIG. 7, at the peak of the pulsed light (Bj) returned from the j-th sensor head, the dip caused by the absorption of the optical signal by the methane gas is observed. By detecting the amount of the dip in the photodiode 116 and the signal processing unit 117, it is possible to know the concentration of the methane gas around the j-th sensor head. The photodiode 116 outputs, to the signal processing unit 117, the electric signal having the amplitude that is proportional to the light intensity. The signal processing unit 117 monitors the temporal intensity change of the electric signal at the peak of the pulse light for each peak and detects the dip of the absorption of the gas.

Processes by the signal processing unit 117 are similar to those in the first example embodiment. In other words, the signal processing unit conducts, for example, the following operations. The signal processing unit 117 detects the depth of the dip of the j-th peak (i.e., amplitude change). When the amplitude change is larger than the predetermined threshold value, the signal processing unit 117 determines that the gas is leaking around the sensor head 530-j and outputs the alarm to the outside of the control device 510. Alternatively, the signal processing unit 117, based on the depth of the dip of the j-th peak, calculates the concentration of the gas around the sensor head 530-j and outputs the calculated gas concentration to the outside of the control device 510.

(Effect of Second Example Embodiment)

The gas detection system 2 according to the second example embodiment, similarly to the first example embodiment, can conduct the gas detection of the multiple locations with the simple configuration. The first reason thereof is because, since the wavelength of the output light of the light source of the single wavelength is changed using the optical wavelength modulator 114, the light source that generates the pulse light whose output is high and whose spectrum is broad is not needed. The second reason is because since the turned back optical signal is received only by the photodiode 116 and the signal processing unit 117, at the receiving side, the complicated optical circuit is not needed.

Further, the gas detection system 2 according to the second example embodiment can realize the gas detection system having the high distance resolution. The reason thereof is because the wavelength of the short pulse output from the light source of the single wavelength is changed using the optical wavelength modulator 114. With such configuration, compared to when the pulse light having the wide spectrum is used, the widening of the pulse width of the optical signal can be reduced and compared to when the wavelength modulation is conducted based on the drive current and the temperature of the laser, with the short pulse, the desired wavelength change can be obtained. As a result, even when the distance between the sensor heads 530 is small, it is possible to avoid that the return light pulses from the plurality of measurement points temporally overlap at the control device 510 and the high distance resolution can be obtained. The gas detection system 2 according to the second example embodiment, to provide the above described effects, does not need to arrange the optical fiber spool on the optical fibers 520 and 521.

Further, the gas detection system 2 according to the second example embodiment can reduce the operational cost of the gas detection system. The reason thereof is because compared to when the optical fiber is laid from the control device 510 for each sensor head, the gas detection system 2, by inserting the optical coupler to two fibers, can conduct the gas detection of the many points. The gas detection system 2 facilitates the construction and the maintenance of the system and can relatively easily introduce the gas detection system to the region where there are few free optical fibers in the existing optical fiber network.

The gas detection system 2 according to the second example embodiment, compared to the first example embodiment, can conduct the signal detection having the preferable signal-to-noise ratio. The reasons are as follows. The gas detection system 1 according to the first example embodiment uses the single optical fiber 120 for both the transmission and the reception of the optical signal. For this reason, the light by the Rayleigh backscattering enters the photodiode 116 as the noise and as a result, there is a possibility that the signal-to-noise ratio of the optical signal turned back by the sensor head 130 is lowered. However, since the gas detection system 2 according to the second example embodiment uses the different optical fibers 520 and 521 for the transmission and the reception of the optical signal, it is possible to lower the influence of the noise caused by the Rayleigh backscattering.

Note that in the second example embodiment also, similarly to the variation of the first example embodiment, different modulators, optical amplifiers, spectroscopic methods, wavelengths and the like may be used.

### Third Example Embodiment

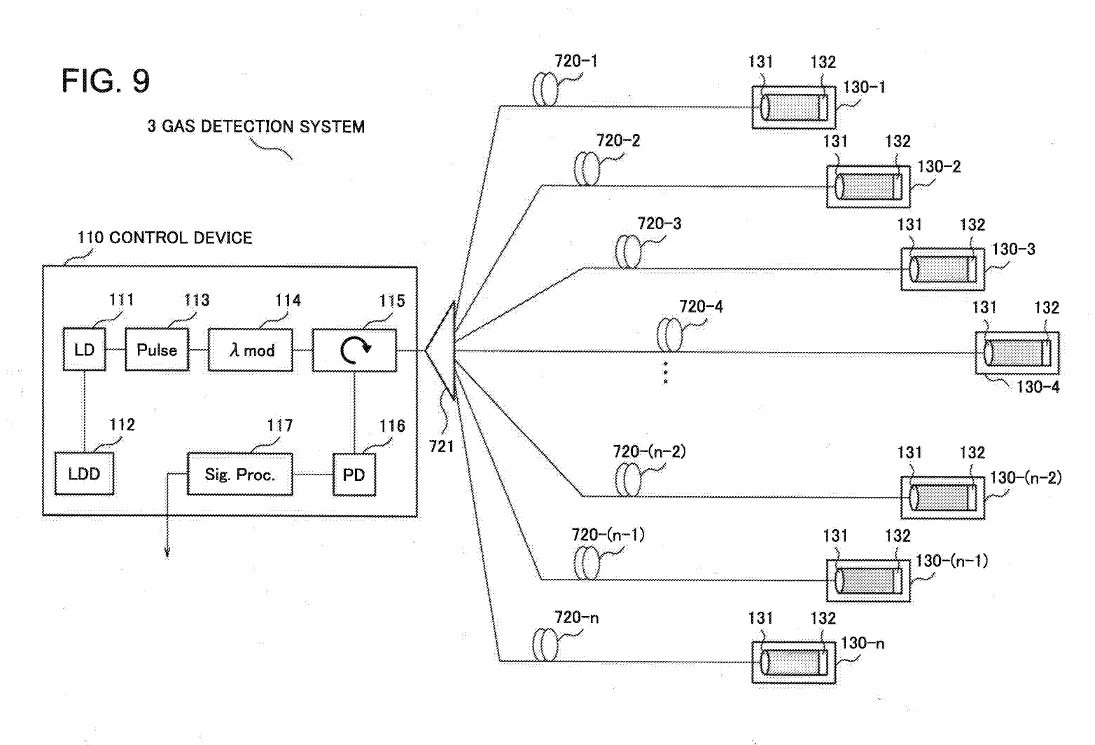

With reference to FIG. 9 to FIG. 11, the third example embodiment is described. In the gas detection system 1 according to the first example embodiment, from the optical coupler 121 cascaded to the optical fiber 120 to the sensor head 130, the optical signal is split. On the other hand, the gas detection system according to the third example embodiment, using the optical coupler that conducts the one-to-many splitting on the optical signal, accommodates the plurality of sensor heads. In the third example embodiment, when, for example, the optical fiber for Passive Optical Network (PON) laid for Fiber To The Home (FTTH) service is utilized is assumed.

(Configuration of Third Example Embodiment)

FIG. 9 is a block diagram illustrating a configuration example a gas detection system 3 according to the third example embodiment of the present invention. The gas detection system 3 includes a control device 110, optical fibers 720-1 to 720-n, an optical coupler 721, and sensor heads 130-1 to 130-n. The n is the integer of two or more. Below, the optical fibers 720-1 to 720-n are collectively referred to as an optical fiber 720. The optical coupler 721 is, for example, a 1×n optical star coupler.

The control device 110 includes a laser diode 111, a laser diode driver 112, an optical intensity modulator 113, an optical wavelength modulator 114, a photodiode 116, and a signal processing unit 117. The control device 110 is a device that is similar to the control device 110 used in the gas detection system 1 according to the first example embodiment. The sensor heads 130-1 to 130-n also have a configuration similar to that of the sensor heads 130-1 to 130-n used in the gas detection system 1 according to the first example embodiment. Accordingly, with respect to the control device 110 and the sensor head 130, in the following descriptions, the descriptions duplicated with those in the first example embodiment are omitted.

In the present example embodiment, the input/output port of the control device 110 is connected to the common port of the optical coupler 721. Each port of the n-branch side of the optical coupler 721 is, via optical fibers 720-1 to 720-n, connected to the sensor heads 130-1 to 130-n. The control device 110 and the sensor head 130 are connected by the optical coupler 721 and the optical fiber 720.

(Operation of Third Example Embodiment)

Similarly to the first example embodiment, the wavelength-modulated optical signal having the wavelength of 1.65 μm is, via the optical circulator 115, sent from the control device 110 to the common port of the optical coupler 721. The optical coupler 721 splits the optical signal and the split optical signal is, via the optical fibers 720-1 to 720-n, sent to the sensor heads 130-1 to 130-n.

The n sensor heads 130 are dispersed and installed to a place where the detection of the leaking of the gas is needed. The sensor head 130 emits the optical signal input from the optical fiber 720 from the optical fiber end and converts the emitted optical signal into the collimated optical signal using the lens 131. The collimated optical signal propagates the atmosphere of the place where the sensor head 130 is installed and is reflected by the mirror 132. The lens 131 converges the reflected collimated optical signal to the optical fiber that emits the optical signal. The optical signal that is converged into the optical fiber propagates the optical fiber 720 and the optical coupler 721 in a reverse direction and is received by the control device 110. In this manner, the optical signal transmitted from the control device 110 returns at the sensor head 130 and is received by the control device 110.

The optical signal received by the control device 110 is guided by the optical circulator 115 to the photodiode 116. The photodiode 116 converts the received optical signal into the electric signal. By processing the obtained electric signal by the signal processing unit 117, the presence or the absence of the methane gas at the points where the sensor head 730 is installed is detected.

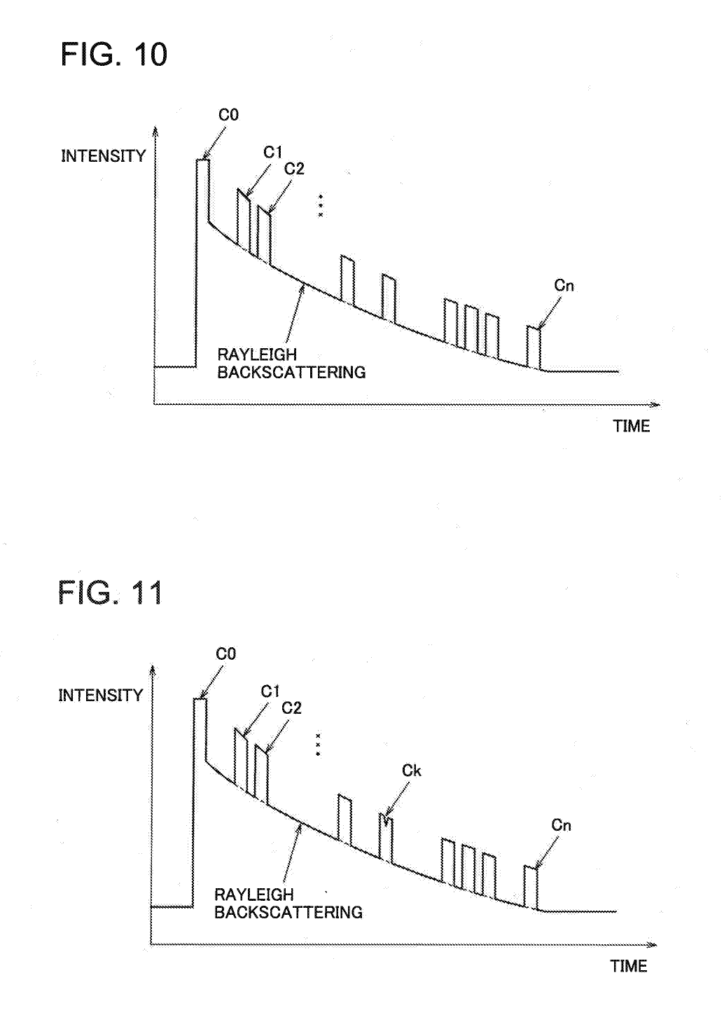

FIG. 10 and FIG. 11 are drawings conceptually illustrating waveform examples of the optical signal received by the photodiode 116. FIG. 10 illustrates an example in which there is no gas leaking at any points where the sensor head is arranged. The first peak (C0) illustrated in FIG. 10 occurs because the pulse light transmitted from the optical wavelength modulator 114 is not sent to the optical fiber 120 but is directly received by the photodiode 116. This is caused by the incompleteness of the directivity of the optical circulator 115. Second and subsequent peaks (C1 to Cn) are respectively peaks corresponding to the pulse light turned back from the sensor heads 130-1 to 130-n.

A position on a time axis of each peak is determined based on the round trip time of the optical signal, i.e., the distance between the control device 110 and the sensor head 130 of the optical signal. In the present example embodiment, each sensor head 130 is arranged in such a way that all distances from the control device 110 are different. It is assumed that the difference in the distance between the control device 110 and each sensor head 130 is a length in which peaks illustrated in FIG. 10 and FIG. 11 at least do not temporally overlap.

In FIG. 10, the dotted line as “Rayleigh backscattering” and the curve indicating the period during which there is no pulse light represent the intensity of the received light caused by the Rayleigh backscattering of the optical fiber. The intensity of the Rayleigh backscattering, as the distance from the control device 110 to the sensor head 130 increases, decreases by the transmission loss of the optical fiber 720. When in all points where the sensor head 130 is installed, there is no gas leaking, as illustrated in FIG. 10, all of the peaks of the pulsed light returned from the sensor head 130 indicate the gentle intensity change. Note that the temporal variation of the signal intensity due to the Rayleigh backscattering illustrated in FIG. 10 and FIG. 11 is one example showing a principle, and the intensity of the Rayleigh backscattering differs depending on the number of branches of the optical coupler 721 and the optical feature of the optical fibers 720-1 to 720-n.

On the other hand, FIG. 11 illustrates an example in which in a point where a k-th (1≤k≤n) sensor head is installed, as the result of gas leaking, the methane gas concentration around the point is high. In this case, unlike FIG. 10, at the peak of the pulsed light (Ck) returned from the k-th sensor head, the dip caused by the absorption of the optical signal by the methane gas is observed. By detecting the amount of the dip in the photodiode 116 and the signal processing unit 117, it is possible to know the concentration of the methane gas around the k-th sensor head. Detection procedures of the methane gas in the signal processing unit 117 are similar to those in the first and second example embodiments.

In a signal waveform observed in the first and second example embodiments (FIG. 4, FIG. 5, FIG. 7 and FIG. 8), the return lights from each sensor head are arranged at regular intervals. This is because the sensor heads 130, 530 are arranged at the constant intervals. On the other hand, in the present example embodiment, the distance from the control device 110 to each sensor head 130 is set only in such a way that the return lights from each sensor head do not collide with the optical coupler 721. In other words, the sensor head 130 is not installed in such a way that the difference in the distance from the control device 110 to each sensor head 130 is constant. Accordingly, the timings of the optical signal that returns from each sensor head 130 are at irregular intervals. Similarly to the first and second example embodiments, it is possible to know the correspondence between the peak of the pulse light and the sensor head 130 by measuring in advance the reception time of the optical signal for each sensor head 130.

(Effect of Third Example Embodiment)

The gas detection system 3 according to the third example embodiment, as similar to the first and second example embodiments, can conduct the gas detection of the multiple locations with the simple configuration. The first reason thereof is because since the wavelength of the output light of the light source of the single wavelength is changed using the optical wavelength modulator 114, the light source that generates the pulse light whose output is high and whose spectrum is broad is not needed. The second reason is because since the turned back optical signal is received only by the photodiode 116 and the signal processing unit 117, to the receiving side, the complicated optical circuit is not needed.

Further, the gas detection system 3 according to the third example embodiment can realize the gas detection system having the high distance resolution. The reason thereof is because the wavelength of the short pulse output from the light source of the single wavelength is changed using the optical wavelength modulator 114. With such configuration, compared to when the pulse light having the wide spectrum is used, the widening of the pulse width of the optical signal can be reduced and compared to when the wavelength modulation is conducted based on the drive current and the temperature of the laser, with the short pulse, the desired wavelength change can be obtained. As a result, even when the distance between the sensor heads 130 is small, it is possible to avoid that the return optical pulses from the plurality of measurement points temporally overlap at the control device 110 and the high distance resolution can be obtained. The gas detection system 3 according to the third example embodiment, to provide the above described effects, does not need to arrange, on the optical fiber 720, the optical fiber spool.

The gas detection system 3 according to the third example embodiment can reduce introduction costs of the system. The reason thereof is because it is possible to utilize, for example, the optical fiber network for PON laid for the FTTH service without newly laying the optical fiber network for conducting the gas detection.

As described in the first example embodiment, by using the pulse light of 50 ns width, if the distance between the measurement points is about 10 m, at respective points, the gas can be detected. Accordingly, if the distance between the sensor heads 130 is several tens of meters, the optical fiber network for PON can be easily applied to the gas detection system 3 according to the third example embodiment.

The gas detection system 3 according to the third example embodiment can reduce the operational cost of the gas detection system. The reason thereof is because compared to when for each sensor head, the optical fiber is laid from the control device 110, since the gas detection system 3, by using the optical fiber network for PON, can conduct the gas detection of the many points, the construction and the maintenance of the system are easy.

Note that in the third example embodiment also, as similar to variations of the first and second example embodiments, different modulators, optical amplifiers, spectroscopic methods, wavelengths and the like may be used. First to third variations that provide effects similar to effects in the gas detection system 3 described with reference to FIG. 9 are described below.

(First Variation of Third Example Embodiment)

The gas detection system using the optical fiber for PON may be concurrently used with the FTTH service that is already provided to the subscriber. For example, the optical signal of the wavelength (for example, 1.65 μm) used in the gas detection system and the optical signal of the waveband used at the FTTH service (for example, 1.3 μm and 1.55 μm) may be wavelength-multiplexed on the optical fiber for PON and transmitted. With such configuration, it is possible to simultaneously provide the FTTH service and the gas detection service to the subscriber.

(Second Variation of Third Example Embodiment)

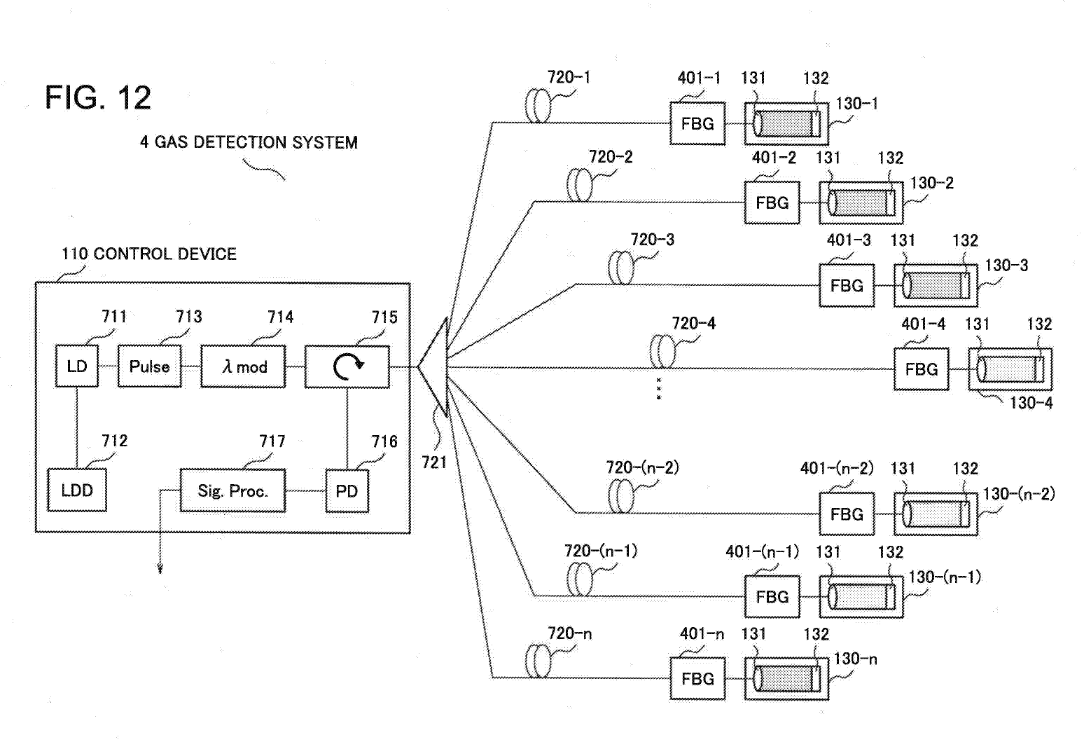

In the third example embodiment, a configuration in which the sensor head 130 corresponding to the detected peak is identified is described. FIG. 12 is a block diagram illustrating a configuration example of a gas detection system 4 as the second variation of the third example embodiment. The gas detection system 4 differs from the gas detection system 3 illustrated in FIG. 9 in that the sensor heads 130-1 to 130-n and Fiber Bragg Grating (FBG) 401-1 to 401-n are arranged in series. Hereinafter, the FBGs 401-1 to 401-n are collectively referred to as an FBG 401.

The FBG 401 reflects a partial wavelength of the input optical signal and causes the optical signal of other wavelengths to be passed. Thus, in FIG. 12, a partial wavelength of the optical signal directed from the optical coupler 721 to the sensor head 130 is first reflected at the FBG 401. Then, the optical signal that has passed through the FBG 401 reciprocates the sensor head 130.

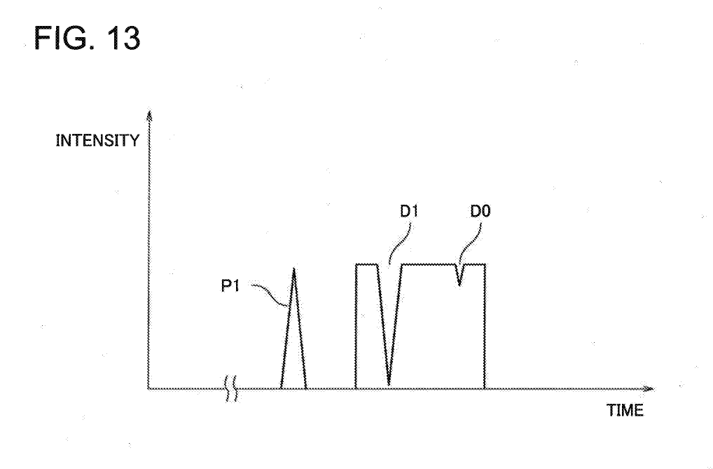

FIG. 13 is a drawing schematically illustrating a shape of a single peak (that is, any one of C1 to Cn) of the optical signal received by the control device 110 in the gas detection system 4. FIG. 13 does not illustrate the influence by the Rayleigh backscattering. As illustrated in FIG. 13, the peak P1 of the optical signal reflected at the FBG 401 first arrives at the control device 110 then, the optical signal that passes through the sensor head arrives. In the optical signal that passes through the sensor head, in addition to the absorption dip D0 by the gas, the dip D1 of the wavelength reflected by the FBG 401 are found.

The wavelength of the optical signal input to the FBG 401 temporally changes within the light-emitting period of the single pulse light. Accordingly, the peak P1 of the reflected light from the FBG 401 and the timing of the dip D1 by the FBG 401 depend on the reflection wavelength of the FBG 401. By using this, based on the peak P1 of the received optical signal and the timing of the dip D1, the control device 110 determines from which one of the sensor heads 130-1 to 130-n, the pulse of the optical signal comes.

The wavelength of the optical wavelength modulator 714 is swept in such a way as to be expanded to the absorption band of the methane at the start of the emission of the pulse light. For each sensor head 130, the FBG 401 that reflects the different wavelengths is inserted. All of the wavelengths reflected by the FBG 401 are set in such a way as to be included in the waveband of the expanded absorption band of the methane. By setting the reflection wavelength of the FBG 401 and the swept wavelength of the optical wavelength modulator 714 in this manner, it is possible to avoid that the dip D1 in the received pulse light overlaps with the dip by the absorption of the methane.

A signal processing unit 717 stores the timings of the peak P1 and the dip D1 in advance as reference values for each sensor head 130. The reference value can be obtained by actual measurements based on a rise time or a fall time of the pulse light of, for example, the received optical signal. Since all of the reflection wavelengths of the FBG 401 differ, the timings of the peak P1 and the dip D1 also differ for each FBG 401 (i.e., for each sensor head 130). The signal processing unit 717, with respect to the respective received optical signals, measures the timing of the peak or the dip different from the absorption by the gas. The signal processing unit 717 compares the measured value with the stored reference value and determines that the sensor head 130 having the timing closest to the measured value is the sensor head 130 corresponding to the optical signal. Note that as similar to the first and second example embodiments, sensors 130 are connected in advance one by one and a timing at which the corresponding peaks C1 to Cn occur is measured in advance in such a way as to be known the correspondence between the received peaks C1 to Cn and the sensor heads 130-1 to 130-n.

(Third Variation of Third Example Embodiment)

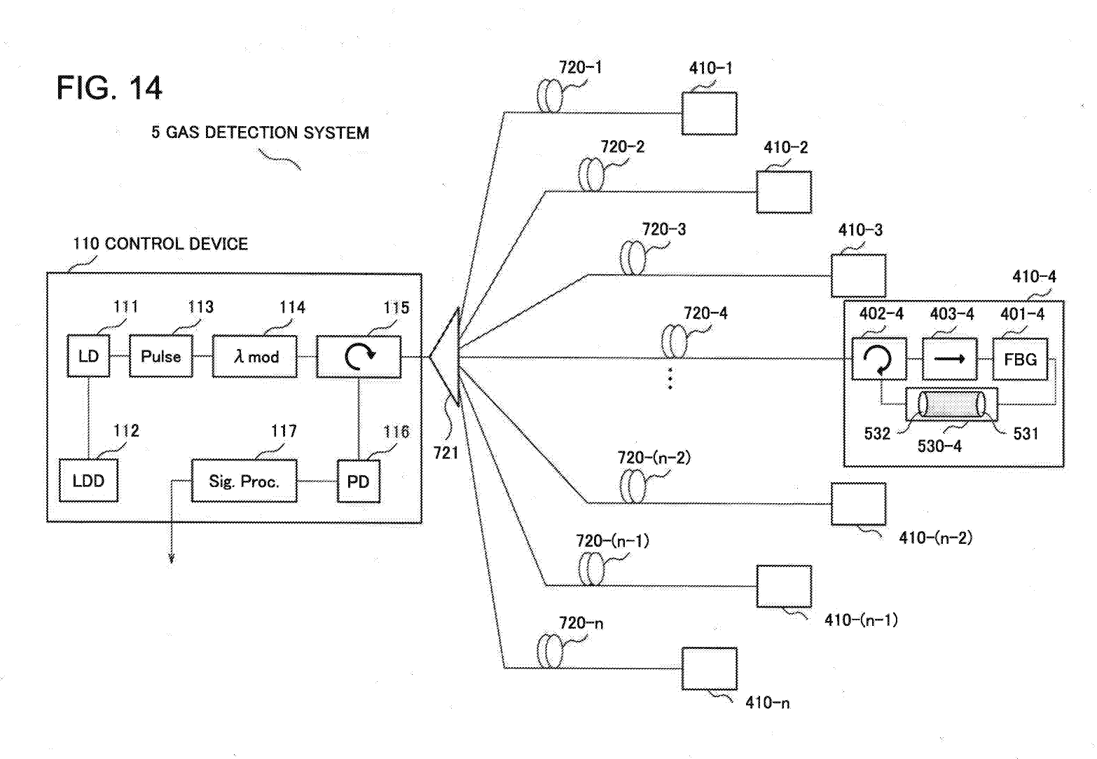

FIG. 14 is a block diagram illustrating a configuration example of a gas detection system 5 as the third variation of the third example embodiment. The gas detection system 5, compared with FIG. 12, instead of the sensor head 130 and the FBG 401, includes sensor units 410-1 to 410-n. The sensor units 410-1 to 410-n are collectively referred to as a sensor unit 410 below.

The sensor unit 410 includes the sensor head 530 that is similar to that in the second example embodiment, the FBG 401, an optical circulator 402, and an isolator 403. As an example, the sensor unit 410-4 connected to the optical fiber 720-4 is described. The FBG 401-4 reflects a partial wavelength of the input optical signal and causes the optical signal of other wavelengths to be passed. In FIG. 14, the optical signal that is input from the optical coupler 721 to the sensor unit 410-4 passes through the optical circulator 402-4 and the isolator 403-4 and at the FBG 401-4, the partial wavelength of the optical signal is reflected. However, the optical signal reflected at the FBG 401-4 is blocked at the isolator 403-4. The optical signal that passes through the FBG 401-4 passes through the sensor head 530-4 and receives the absorption corresponding to the concentration of the gas. The optical signal that passes through the sensor head 530-4 is transmitted to the control device 110 via the optical circulator 402-4.

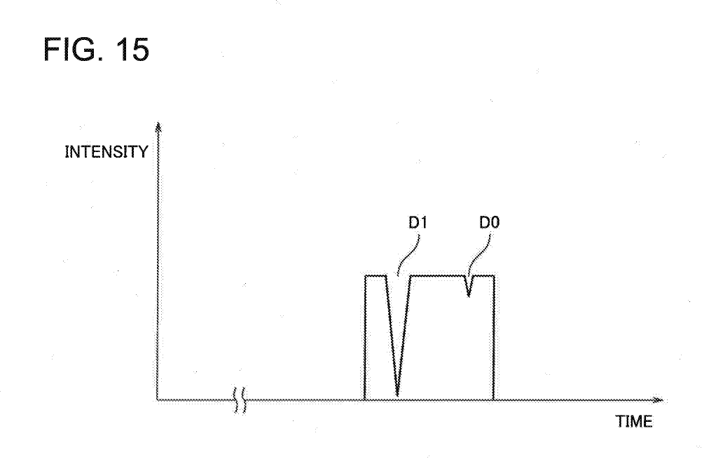

FIG. 15 is a drawing schematically illustrating the peak shape of the optical signal received by the control device 110 in the gas detection system 5. FIG. 15 does not illustrate the influence by the Rayleigh backscattering. In the gas detection system 5, the optical signal reflected at the FBG 401 is blocked at the isolator 403. Therefore, unlike the gas detection system 4, the peak P1 by the light reflected at the FBG 401 is not received by the control device 110. In the optical signal that permeates the sensor head 530, similarly to the gas detection system 4, in addition to the absorption dip D0 by the gas, the dip D1 of the wavelength reflected by the FBG 401 is found. Accordingly, the control device 110 measures the timing of the dip D1 and compares the timing with the reference value in such a way as to identify the sensor head 530 corresponding to the received pulse light.

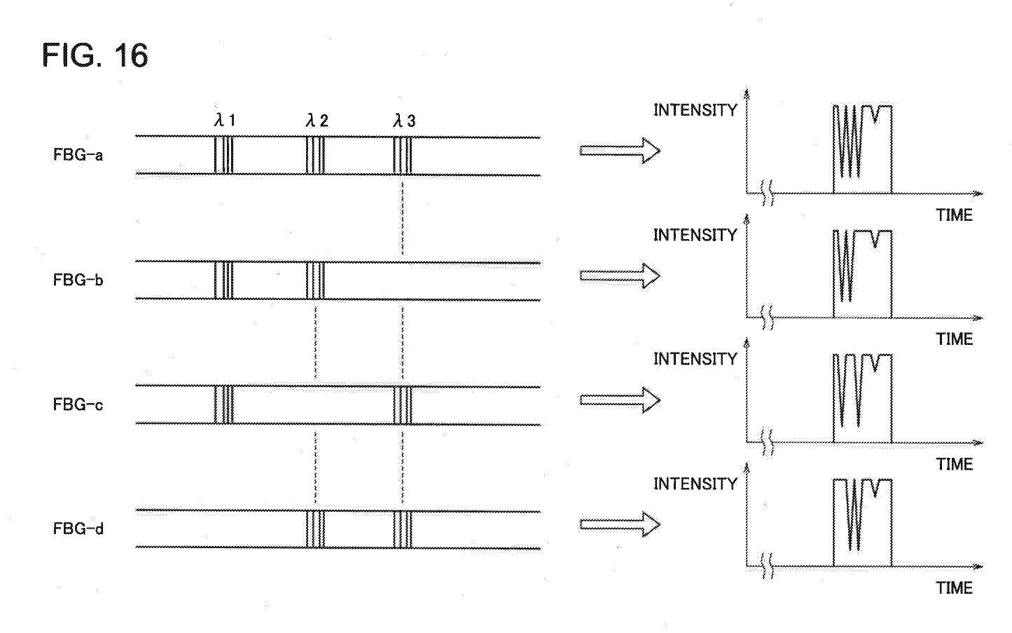

FIG. 16 is a drawing for explaining an example of the correspondence between the reflection wavelength set to the FBG 401 and the peak waveform of the optical signal received by the control device 110. Different reflection wavelengths are set for four types of FBGs (FBG-a to FBG-d). The FBG-a reflects the light of the wavelengths λ1, λ2, λ3, the FBG-b reflects the light of the wavelengths λ1, λ2, the FBG-c reflects the light of the wavelengths λ1, λ3, and the FBG-d reflects the light of the wavelengths λ2, λ3. On the right side of FIG. 16, an example of the peak waveform of the optical signal that passes the sensor head 530 and is received by the control device 110 when the sensor unit 410 includes any of FBG-a to FBG-d is illustrated. Since to the peak waveform of the optical signal, the dip corresponding to the reflection wavelength of the FBG 401 appears, by detecting the timing of the dip, it is possible to identify the sensor head corresponding to the received pulse light.

### Fourth Example Embodiment

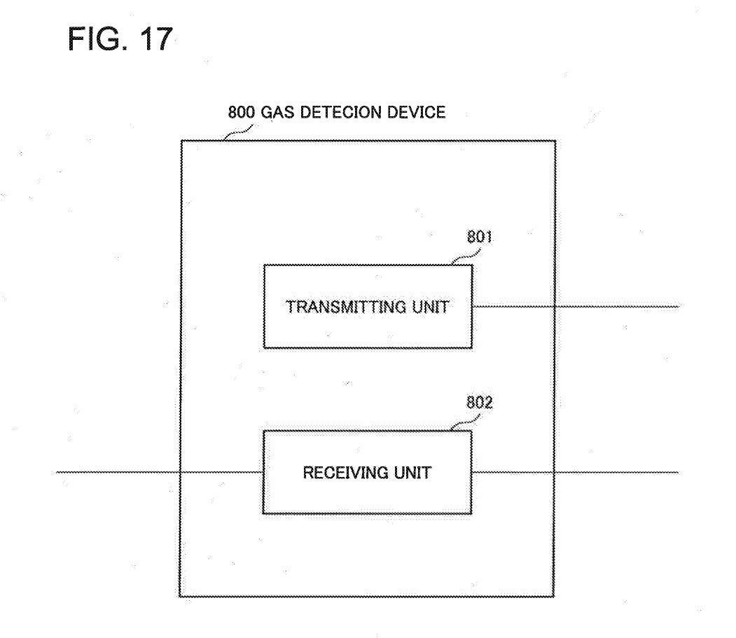

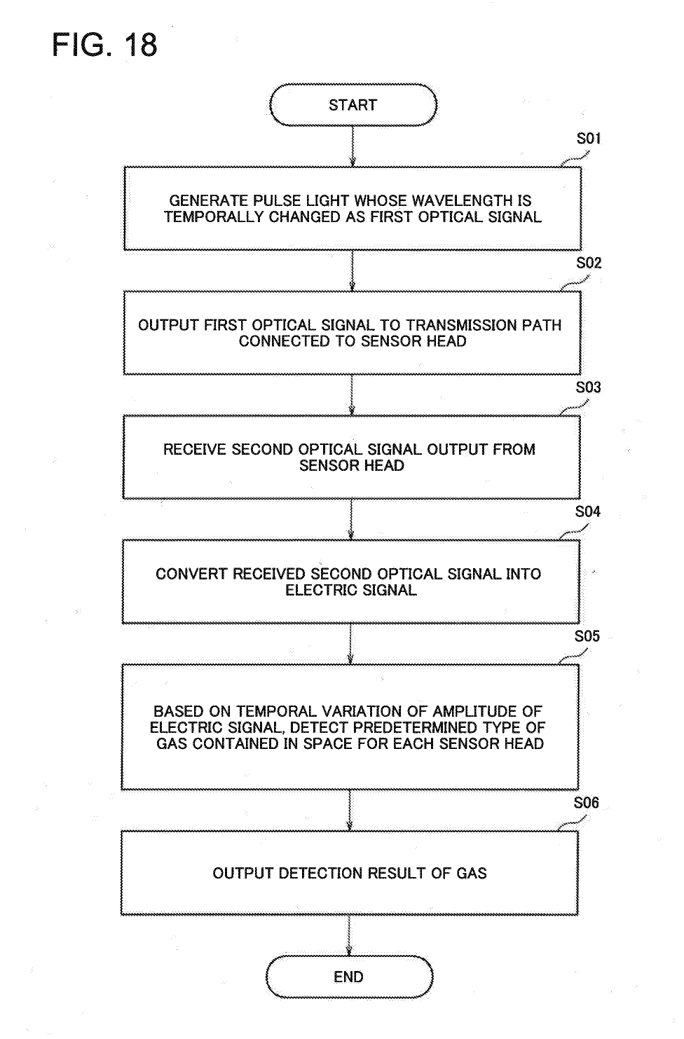

FIG. 17 is a block diagram illustrating a configuration example of a gas detection device 800 according to the fourth example embodiment. FIG. 18 is a flowchart illustrating an example of the operation procedures of the gas detection device 800. The control device 510 according to the second example embodiment described with reference to FIG. 6 can be also referred to as the gas detection device 800 having the following configurations. In other words, the gas detection device 800 includes a transmitting unit 801 and a receiving unit 802. The transmitting unit 801 includes the optical wavelength modulator 114 of FIG. 6. Further, the transmitting unit 801 may include the laser diode 111, the laser diode driver 112, the optical intensity modulator 113 and the optical wavelength modulator 114 of FIG. 6. The receiving unit 802 may include the photodiode 116 and the signal processing unit 117 of FIG. 6.

The transmitting unit 801 generates the pulse light whose wavelength is temporally changed, which pulse light is generated by optical wavelength modulator (step S01 of FIG. 18), and outputs the pulse light as the first optical signal to the transmission path connected to the sensor head (step S02). The sensor head outputs the first optical signal that is propagated through the atmosphere as the second optical signal. The receiving unit 802 receives the second optical signal output from the sensor head (step S03) and converts the second optical signal into the electric signal (step S04). The receiving unit 802, based on the temporal variation of the amplitude of the electric signal, detects the predetermined types of gas contained in the space for each sensor head (step S05), and outputs the detection result of the gas (step S06).

The gas detection device 800 according to the fourth example embodiment can conduct the gas detection of the multiple locations with the simple configuration. The first reason thereof is because since by using the optical wavelength modulator, the wavelength of the light source is changed and the first optical signal is generated, the light source that generates the pulse light whose output is high and whose spectrum is broad is not needed. The second reason is because, for receiving the second optical signal, the complicated optical circuit is not needed.

Further, the gas detection device 800 according to the fourth example embodiment can realize the gas detection system having the high distance resolution. The reason thereof is because the wavelength of the short pulse output from the light source of the single wavelength is changed using the optical wavelength modulator. With such configuration, compared to when the pulse light having the wide spectrum is used, the spread of the pulse width of the optical signal can be reduced and compared to when the wavelength modulation is conducted based on the drive current and the temperature of the laser, with the short pulse, the desired wavelength change can be obtained. As a result, even when the distance between the sensor heads is small, it is possible to avoid that the return light pulses from the plurality of measurement points temporally overlap at the gas detection device and the high distance resolution can be obtained. The gas detection device 800 according to the fourth example embodiment, to provide the above described effects, does not need to arrange, on the transmission path, the spool of the transmission medium.

Functions and procedures described in each example embodiment above may be realized by a central processing unit (CPU) included in the control device 110 or 510, or the gas detection device 800 executing the program. The program is recorded in the, tangible, non-transitory recording medium. As the recording medium, the semiconductor memory or the fixed magnetic disk device is used, but the medium is not limited thereto. The CPU is, for example, a computer included in the signal processing unit 117, 517 or the transmitting unit 801. However, the CPU may be included in the control unit 205 or the receiving unit 802.

Note that although the example embodiments of the present invention can be described as following supplementary notes, the example embodiments are not limited thereto.

(Supplementary Note 1)

A gas detection system comprising:

transmission means for outputting pulse light whose wavelength is temporally modulated by an optical wavelength modulator to a transmission path as a first optical signal;

a plurality of sensor heads for propagating the first optical signal through an atmosphere and outputting the first optical signal that has propagated the atmosphere as a second optical signal;

reception means for receiving the second optical signal, converting the second optical signal into an electric signal, based on a temporal variation of an amplitude of the electric signal, detecting a predetermined type of gas included in the atmosphere for each sensor head, and outputting a detection result of the gas; and

splitting means for splitting the transmission path, via the transmission path split, connecting the transmission means to the sensor head, and via the transmission path split, connecting the sensor head to the reception means.

(Supplementary Note 2)

The gas detection system according to supplementary note 1, wherein the transmission path is an optical fiber transmission path and the first optical signal and the second optical signal are transmitted via different optical fiber transmission paths.

(Supplementary Note 3)

The gas detection system according to supplementary note 1, further comprising:

an optical circulator for connecting the transmission means and the reception means to the transmission path, wherein

the transmission path is an optical fiber transmission path; and

the reception means receives the second optical signal that is output, by the sensor head, to the optical fiber transmission path that is the same as the optical fiber transmission path to which the first optical signal is output.

(Supplementary Note 4)

The gas detection system according to supplementary note 3, wherein the splitting means is a 1×N (N is an integer of two or more) optical coupler.

(Supplementary Note 5)

The gas detection system according to supplementary note 3 or 4, wherein

to the each of the sensor heads, a Fiber Bragg Grating (FBG), each of transmission wavelength of the FBG being different, is connected, the second optical signal passes through the FBG and is output to the splitting means, and the reception means, based on a timing of an amplitude change of the pulse light included in the second optical signal, identifies the sensor head.

(Supplementary Note 6)

The gas detection system according to any one of supplementary notes 1 to 5, wherein

the optical wavelength modulator includes an optical Single Side Band (SSB) modulator, and the optical SSB modulator changes a wavelength of the pulse light for each pulse temporally.

(Supplementary Note 7)

The gas detection system according to any one of supplementary notes 1 to 5, wherein

the optical wavelength modulator includes an optical phase modulator and the optical phase modulator changes a wavelength of the pulse light for each pulse temporally.

(Supplementary Note 8)

The gas detection system according to any one of supplementary notes 1 to 7, wherein

the transmission means and the reception means, based on a wavelength modulation spectroscopy, conduct a generation of a first optical signal and a process of a second optical signal.

(Supplementary Note 9)

The gas detection system according to any one of supplementary notes 1 to 8, wherein

between the transmission means and the transmission path, an optical filter that reduces light of a higher order wavelength included in the first optical signal is provided.

(Supplementary Note 10)

The gas detection system according to any one of supplementary notes 1 to 9, wherein

the transmission means includes a laser diode that generates continuous light, a laser diode driver that controls the laser diode, an optical intensity modulator that pulse-modulates the continuous light, and the optical wavelength modulator that wavelength-modulates the pulse-modulated light and generates the pulse light.

(Supplementary Note 11)

The gas detection system according to any one of supplementary notes 1 to 10, wherein

the reception means includes a photodiode that converts the second optical signal received into the electric signal and a signal processing unit that processes the electric signal.

(Supplementary Note 12)

The gas detection system according to any one of supplementary notes 1 to 11, wherein the reception means, based on a temporal variation of an amplitude of the electric signal, detects a concentration of the gas for each sensor head.

(Supplementary Note 13)

A gas detection device comprising:

transmission means for outputting pulse light whose wavelength is temporally changed, which pulse light is modulated by an optical wavelength modulator to a transmission path as a first optical signal; and

reception means for receiving a second optical signal output from a sensor head that outputs the first optical signal that has propagated an atmosphere as the second optical signal, converting the second optical signal into an electric signal, based on a temporal variation of an amplitude of the electric signal, detecting a predetermined type of gas included in the atmosphere for each sensor head, and outputting a detection result of the gas.

(Supplementary Note 14)

A control method of a gas detection device comprising:

outputting pulse light whose wavelength is temporally changed, which pulse light is modulated by an optical wavelength modulator to a transmission path as a first optical signal;

receiving a second optical signal output from a sensor head that outputs the first optical signal that has propagated an atmosphere as the second optical signal and converting the second optical signal into an electric signal;

based on a temporal variation of an amplitude of the electric signal, detecting a predetermined type of gas included in the atmosphere for each sensor head; and

outputting a detection result of the gas.

(Supplementary Note 15)

A control program of a gas detection device for causing a computer of a gas detection device to execute the procedures of:

outputting pulse light whose wavelength is temporally changed, which pulse light is modulated by an optical wavelength modulator to a transmission path as a first optical signal;

receiving a second optical signal output from a sensor head that outputs the first optical signal that has propagated an atmosphere as the second optical signal and converting the second optical signal into an electric signal;

based on a temporal variation of an amplitude of the electric signal, detecting a predetermined type of gas included in the atmosphere for each sensor head; and

outputting a detection result of the gas.

Above, although with reference to example embodiments, the present invention has been described, the present invention is not limited to the above described example embodiments. Various modification that could be understood by a person skilled in the art within a scope of the present invention can be made to a configuration and details of the present invention. Further, components of each example embodiment can be combined as long as there is no inconsistency.

This application claims priority based on Japanese Patent Application No. 2015-228374 filed on Nov. 24, 2015, the disclosure of which is incorporated herein in its entirety.

### INDUSTRIAL APPLICABILITY

The present invention can be applied to a measurement system of a gas concentration. In particular, the present invention can be applied to a system that remotely measures gas concentration information of multiple locations in a wide area.

### REFERENCE SIGNS LIST

1 to 5 Gas detection system

110, 510 Control device

111 Laser diode

112 Laser diode driver

113 Optical intensity modulator

114 Optical wavelength modulator

115 Optical circulator

116 Photodiode

117, 517 Signal processing unit

120, 520, 521, 720 Optical fiber

121, 522, 523, 721 Optical coupler

130, 430, 530, 730 Sensor head

131, 531, 532 Lens

132 Mirror

201 Variable oscillator

203 Phase shifter

204 Modulator

205 Control unit

402 Optical circulator

403 Isolator

410 Sensor unit

800 Gas detection device

801 Transmitting unit

802 Receiving unit

1. A gas detection system comprising:
a transmitter configured to output pulse light whose wavelength is temporally modulated, which pulse light is modulated by an optical wavelength modulator to a transmission path as a first optical signal;
a plurality of sensor heads configured to propagate the first optical signal during an atmosphere and outputting the first optical signal that has propagated the atmosphere as a second optical signal;
a receiver configured to receive the second optical signal, convert the second optical signal into an electric signal, based on a temporal variation of an amplitude of the electric signal, detect a predetermined type of gas included in the atmosphere for each sensor head, and output a detection result of the gas; and
a splitter configured to split the transmission path, via the transmission path split, connecting the transmitter to the sensor head, and via the transmission path split, connecting the sensor head to the receiver.

2. The gas detection system according to claim 1, wherein
the transmission path is an optical fiber transmission path and the first optical signal and the second optical signal are transmitted via different optical fiber transmission paths.

3. The gas detection system according to claim 1, further comprising:
an optical circulator that connects the transmitter and the receiver to the transmission path, wherein
the transmission path is an optical fiber transmission path, and the receiver receives the second optical signal, output by the sensor head, to the optical fiber transmission path that is a same as the optical fiber transmission path to which the first optical signal is output.

4. The gas detection system according to claim 3, wherein the splitter is a 133 N (N is an integer of two or more) optical coupler.

5. The gas detection system according to claim 3, wherein
to each of the sensor head, a Fiber Bragg Grating (FBG), each of transmission wavelength of the FBG being different, is connected, the second optical signal passes through the FBG and is output to the splitter, and the receiver, based on a timing of an amplitude change of the pulse light included in the second optical signal, identifies the sensor head.

6. The gas detection system according to claim 1, wherein
the optical wavelength modulator includes an optical Single Side Band (SSB) modulator, and the optical SSB modulator changes a wavelength of the pulse light for each pulse temporally.

7. The gas detection system according to claim 1, wherein
the optical wavelength modulator includes an optical phase modulator and the optical phase modulator changes a wavelength of the pulse light for each pulse temporally.

8. The gas detection system according to claim 1, wherein
the transmission means and the receiver, based on a wavelength modulation spectroscopy, conduct a generation of a first optical signal and a process of a second optical signal.

9. A gas detection device comprising:
a transmitter configured to output pulse light whose wavelength is temporally changed to a transmission path as a first optical signal; and
a receiver configured to receive a second optical signal output from a sensor head that outputs the first optical signal that has propagated an atmosphere as the second optical signal, convert the second optical signal into an electric signal, based on a temporal variation of an amplitude of the electric signal, detect a predetermined type of gas included in the atmosphere for each sensor head, and output a detection result of the gas.

10. A control method of a gas detection device comprising:
outputting pulse light whose wavelength is temporally changed to a transmission path as a first optical signal;
receiving a second optical signal output from a sensor head that outputs the first optical signal that has propagated an atmosphere as the second optical signal, and converting the second optical signal into an electric signal;
based on a temporal variation of an amplitude of the electric signal, detecting a predetermined type of gas included in the atmosphere for each sensor head; and
outputting a detection result of the gas.

11. The gas detection system according to claim 4, wherein
to each of the sensor head, a Fiber Bragg Grating (FBG), each of transmission wavelength of the FBG being different, is connected, the second optical signal passes through the FBG and is output to the splitter, and the receiver, based on a timing of an amplitude change of the pulse light included in the second optical signal, identifies the sensor head.

12. The gas detection system according to claim 2, wherein
the optical wavelength modulator includes an optical Single Side Band (SSB) modulator, and the optical SSB modulator changes a wavelength of the pulse light for each pulse temporally.

13. The gas detection system according to claim 3, wherein
the optical wavelength modulator includes an optical Single Side Band (SSB) modulator, and the optical SSB modulator changes a wavelength of the pulse light for each pulse temporally.

14. The gas detection system according to claim 4, wherein
the optical wavelength modulator includes an optical Single Side Band (SSB) modulator, and the optical SSB modulator changes a wavelength of the pulse light for each pulse temporally.

15. The gas detection system according to claim 5, wherein
the optical wavelength modulator includes an optical Single Side Band (SSB) modulator, and the optical SSB modulator changes a wavelength of the pulse light for each pulse temporally.

16. The gas detection system according to claim 2, wherein
the optical wavelength modulator includes an optical phase modulator and the optical phase modulator changes a wavelength of the pulse light for each pulse temporally.

17. The gas detection system according to claim 3, wherein
the optical wavelength modulator includes an optical phase modulator and the optical phase modulator changes a wavelength of the pulse light for each pulse temporally.

18. The gas detection system according to claim 4, wherein
the optical wavelength modulator includes an optical phase modulator and the optical phase modulator changes a wavelength of the pulse light for each pulse temporally.

19. The gas detection system according to claim 5, wherein
the optical wavelength modulator includes an optical phase modulator and the optical phase modulator changes a wavelength of the pulse light for each pulse temporally.

20. The gas detection system according to claim 2, wherein
the transmission means and the receiver, based on a wavelength modulation spectroscopy, conduct a generation of a first optical signal and a process of a second optical signal.
